(19) United States
(12) Patent Application Publication
(10) Pub. No.: US 2015/0248374 A1
(43) Pub. Date: Sep. 3, 2015

(54) TWIDDLE FACTOR GENERATION

(71) Applicant: QUALCOMM INCORPORATED, SAN DIEGO, CA (US)

(72) Inventors: Hung-Chih Lai, San Diego, CA (US); Samuel Sangmin Rhee, Irvine, CA (US); Dong Wook Seo, San Diego, CA (US); Raheel Khan, Tustin, CA (US)

(73) Assignee: QUALCOMM INCORPORATED, San Diego, CA (US)

(21) Appl. No.: 14/195,442

(22) Filed: Mar. 3, 2014

(51) Int. Cl. G06F 17/14

(52) U.S. Cl. CPC G06F 17/142

(57) ABSTRACT

Systems and methods for generating twiddle factors are described herein according to various embodiments of the present disclosure. In one embodiment, a method for twiddle factor generation comprises generating a first twiddle phase, wherein the first twiddle phase is from a set of radix-M1 twiddle phases, and M1 is an integer. The method also comprises converting the first twiddle phase into a second twiddle phase, wherein the second twiddle phase is from a set of radix-M2 twiddle phases, and M2 is an integer that is different from M1. The method further comprises generating a twiddle factor based on the second twiddle phase.

### BACKGROUND

1. Field

Aspects of the present disclosure relate generally to Fourier transforms, and more particularly, to twiddle factor generation for Fourier transforms.

2. Background

Discrete Fourier Transforms (DFTs) may be performed in the baseband processor of a wireless device (e.g., mobile wireless device) to convert a time-domain signal into a frequency-domain signal. For example, the baseband processor may perform DFTs for SD-FDMA modulation. Other applications of DFTs include spectral analysis, filtering, data compression, etc. The baseband processor may be programed to perform DFTs of various sizes (e.g., depending on the bandwidth of the signal being processed). For example, a baseband processor complying with a Long Term Evolution (LTE) standard may need to support a plurality of different DFT sizes (e.g., DFTs ranging from a 12-point DFT to a 1536-point DFT).

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method for twiddle factor generation is described herein. The method comprises generating a first twiddle phase, wherein the first twiddle phase is from a set of radix-M1 twiddle phases, and M1 is an integer. The method also comprises converting the first twiddle phase into a second twiddle phase, wherein the second twiddle phase is from a set of radix-M2 twiddle phases, and M2 is an integer that is different from M1. The method further comprises generating a twiddle factor based on the second twiddle phase.

A second aspect relates to a twiddle factor generator. The twiddle factor generator comprises a twiddle phase generator configured to generate a first twiddle phase, wherein the first twiddle phase is from a set of radix-M1 twiddle phases, and M1 is an integer. The twiddle factor generator also comprises a phase converter configured to convert the first twiddle phase into a second twiddle phase, wherein the second twiddle phase is from a set of radix-M2 twiddle phases, and M2 is an integer that is different from M1. The twiddle factor generator further comprises a lookup table (LUT) device configured to generate a twiddle factor based on the second twiddle phase.

A third aspect relates to an apparatus for twiddle factor generation. The apparatus comprises means for generating a first twiddle phase, wherein the first twiddle phase is from a set of radix-M1 twiddle phases, and M1 is an integer. The apparatus also comprises means for converting the first twiddle phase into a second twiddle phase, wherein the second twiddle phase is from a set of radix-M2 twiddle phases, and M2 is an integer that is different from M1. The apparatus further comprises means for generating a twiddle factor based on the second twiddle phase.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an exemplary circuit for performing a radix-3 operation.

FIG. 2 shows an exemplary implementation of a twiddle factor generator.

FIG. 3 shows an example of a relationship between a twiddle phase and a corresponding twiddle factor.

FIG. 4 shows an exemplary implementation of a twiddle factor generator configured to generate twiddle factors for radix operations of different sizes.

FIG. 5 shows a twiddle factor generator configured to generate twiddle factors for radix operations of different sizes according to an embodiment of the present disclosure.

FIG. 6 is a flow diagram illustrating a method for twiddle factor generation according to an embodiment of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Discrete Fourier Transforms (DFTs) may be performed in the baseband processor of a wireless device (e.g., mobile wireless device) to convert a time-domain signal into a frequency-domain signal. For example, the baseband processor may perform DFTs for SD-FDMA modulation. Other applications of DFTs include spectral analysis, filtering, data compression, etc.

The baseband processor may be programed to perform DFTs of various sizes. For example, a baseband processor complying with a Long Term Evolution (LTE) standard may need to support a plurality of different DFT sizes (e.g., DFTs ranging from a 12-point DFT to a 1536-point DFT). The baseband processor may select the size of a DFT based on the bandwidth (e.g., number of subcarriers) of the signal to be processed. For example, the baseband processor may perform a larger DFT for a signal with a larger bandwidth.

To make the computation of a long-point DFT more manageable, the DFT may be decomposed into a plurality of cascaded stages, in which 2-point DFTs (radix-2 operations), 3-point DFTs (radix-3 operations), or 5-point DFTs (radix-5 operations) are performed in each stage. The long-point DFT may be decomposed using a Cooley-Tukey algorithm or other algorithm. For example, a baseband processor may perform a 60-point DFT over four cascade stages, in which radix-5 operations are performed in the first stage, radix-3 operations are performed in the second stage, and radix-2 operations are performed in each of the last two stages (i.e., 5×3×2×2=60). The number of radix operations performed in each stage may be given by the size of the long-point DFT divided by the size of the radix operations in the stage. For example, for a 60-point DFT, 12 radix-5 operations are performed in the first stage, 20 radix-3 operations are performed in the second stage, and 30 radix-2 operations are performed in each of the last two stages. The output samples from each stage except the last stage may be used as the input samples for the next stage.

A radix-M operation is a matrix multiplication given by:

X=W·x (1)

where W is an M by M twiddle matrix, x is an M by one input vector, and X is an M by one output vector. For the example of a radix-3 operation, equation (1) can be written as:

$$[ \begin{matrix}{X}_{0} \\ {X}_{1} \\ {X}_{2}\end{matrix} ] [ \begin{matrix}{W}_{0} & {W}_{3} & {W}_{6} \\ {W}_{1} & {W}_{4} & {W}_{7} \\ {W}_{2} & {W}_{5} & {W}_{8}\end{matrix} ] [ \begin{matrix}{x}_{0} \\ {x}_{1} \\ {x}_{2}\end{matrix} ] \qquad ( 2 )$$

where x₀ to x₂ are the input samples, X₀ to X₂ are the output samples, and W₀ to W₈ are twiddle factors. In general, a twiddle matrix for a radix-M operation comprises M² twiddle factors (e.g., nine twiddle factors for a radix-3 operation).

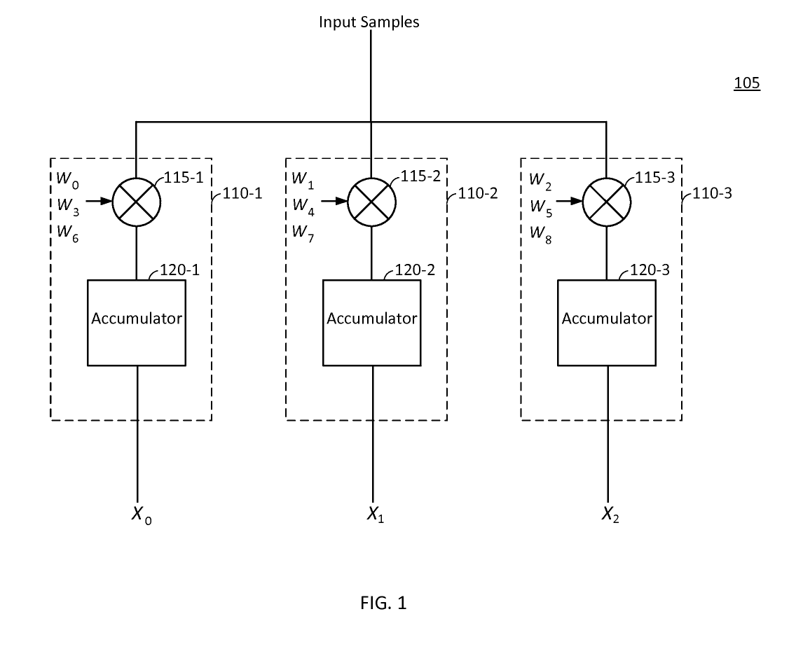

FIG. 1 shows an exemplary implementation of a circuit 105 for performing a radix-3 operation. The circuit 105 comprises three data paths 110-1 to 110-3, where each data path 110-1 to 110-3 receives three input samples (i.e., x₀ to x₂) for the radix-3 operation and generates one of three output samples (i.e., one of X₀ to X₂) for the radix-3 operation. For example, data path 110-1 generates output sample X₀. Each data path 110-1 to 110-3 comprises a multiplier 115-1 to 115-3 configured to multiply each input sample by the respective twiddle factor. For example, multiplier 115-1 multiplies input samples x₀, x₁ and x₂ by twiddle factors W₀, W₃ and W₆, respectively. Each data path 110-1 to 110-3 also comprises an accumulator 120-1 to 120-3 configured to sum the products from the respective multiplier 115-1 to 115-3 to generate the respective output sample. For example, accumulator 120-1 sums products x₀·W₀, x₁·W₃ and x₂·W₆ from multiplier 115-1 to generate output sample X₀.

Circuits for performing radix-2 and radix-5 operations may be implemented in a similar manner. For example, a circuit for performing a radix-5 operation may comprise five data paths, where each data path receives five input samples for the radix-5 operation and outputs one of five output samples for the radix-5 operation. In each data path, a respective multiplier multiplies the five inputs samples by respective twiddle factors and a respective accumulator sums the resulting products from the respective multiplier to generate the respective output sample.

It is to be appreciated that a programmable processor (e.g., vector execution device) comprising reconfigurable data paths, logic and arithmetic devices (e.g., multipliers and accumulators) may be programmed to perform radix-2, radix-3 and radix-5 operations. For example, the processor may be programmed to implement the circuit 105 in FIG. 1 to perform a radix-3 operation. The processor may also be programed (e.g., at a different time) to implement a circuit for performing a radix-2 or a radix-5 operation.

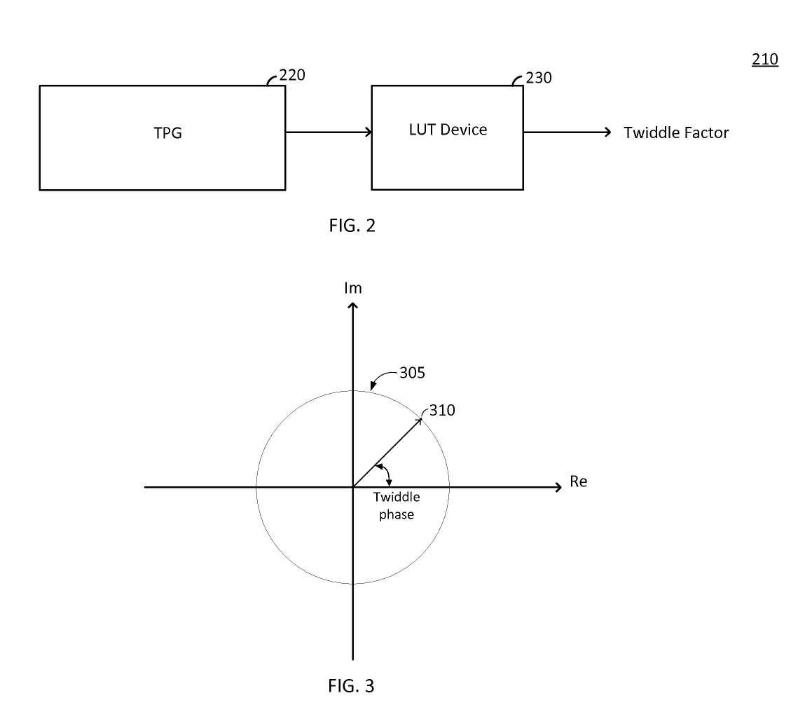

FIG. 2 shows a twiddle factor generator 210 configured to generate twiddle factors for radix operations of a particular size (e.g., radix-2 operations). The twiddle factor generator 210 comprises a twiddle phase generator (TPG) 220 and a lookup table (LUT) device 230. During operation, the TPG 220 generates twiddle phases, and the LUT device 230 converts each twiddle phase into a corresponding twiddle factor.

In one embodiment, the TPG 220 may generate twiddle phases from a set of twiddle phases, and the LUT device 230 may include memory storing a table that maps each twiddle phase in the set of twiddle phases to the corresponding twiddle factor. In this embodiment, the LUT device 230 may convert a twiddle phase to the corresponding twiddle factor using the table. In another embodiment, the table in the LUT device 230 may store twiddle factors for a subset of the twiddle phases in the set of twiddle phases. In this embodiment, the LUT device 230 may determine the twiddle factor for a twiddle phase that is not in the subset using interpolation (e.g., interpolating the twiddle factor from twiddle factors of nearby twiddle phases stored in the LUT device 230).

FIG. 3 shows an example of the relationship between a twiddle phase and the corresponding twiddle factor. As shown in FIG. 3, the twiddle factor is a point 310 on a unit circle 305 in a complex plane corresponding to the twiddle phase. The complex plane has a real (Re) axis and an imaginary (Im) axis, and the twiddle factor is a complex number having a real (Re) part and imaginary (Im) part.

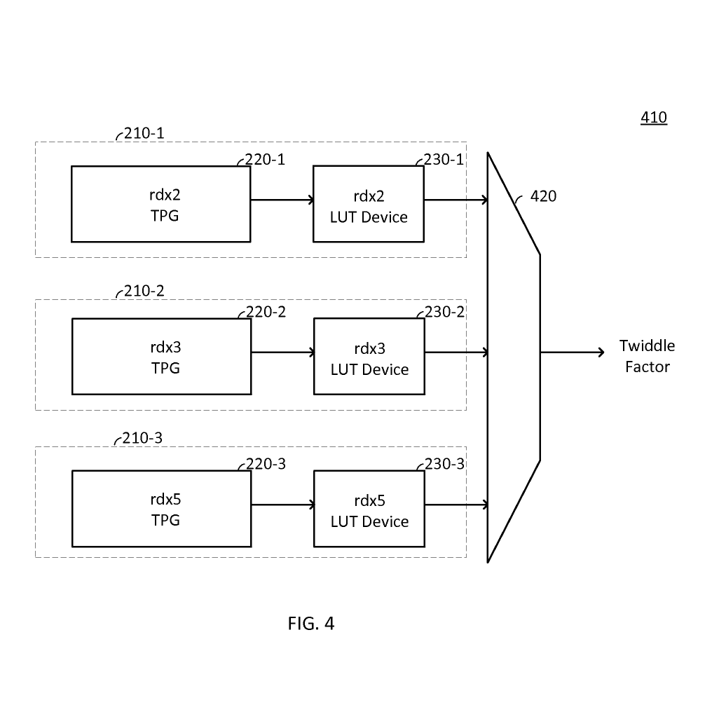

As discussed above, a long-point DFT may be decomposed into a plurality of cascaded stages, in which radix-2 operations, radix-3 operations, or radix-5 operations are performed in each stage. Thus, a twiddle factor generator that is capable of generating twiddle factors for radix operations of different sizes is desirable. In this regard, FIG. 4 shows an exemplary twiddle factor generator 410 capable of generating twiddle factors for radix-2 operations, radix-3 operations, and radix-5 operations.

The twiddle factor generator 410 comprises a radix-2 twiddle factor generator 210-1, a radix-3 twiddle factor generator 210-2, and a radix-5 twiddle factor generator 210-3. Each of the radix-2, radix-3 and radix-5 twiddle factor generators 210-1 to 210-3 comprises a respective TPG 220-1 to 220-3 and LUT device 230-1 to 230-3. In the radix-2 twiddle factor generator 210-1, TPG 220-1 is configured to generate twiddle phases from a set of twiddle phases for radix-2 operations, and LUT device 230-1 is configured to convert the twiddle phases from TPG 220-1 into twiddle factors. In the radix-3 twiddle factor generator 210-2, TPG 220-2 is configured to generate twiddle phases from a set of twiddle phases for radix-3 operations, and LUT device 230-2 is configured to convert the twiddle phases from TPG 220-2 into twiddle factors. In the radix-5 twiddle factor generator 210-3, TPG 220-3 is configured to generate twiddle phases from a set of twiddle phases for radix-5 operations, and LUT device 230-3 is configured to convert the twiddle phases from TPG 220-3 into twiddle factors. The sets of twiddle phases for the twiddle factor generators 210-1 to 210-3 may be different.

The twiddle factor generator 410 also comprises a multiplexer 420 configured to selectively couple the output of one of the radix-2, radix-3 and radix-5 twiddle factor generators 210-1 to 210-3 to a processor (e.g., circuit 105) performing a radix operation depending on the size of the radix operation. More particularly, the multiplexer 420 couples the output of the radix-2 twiddle factor generator 210-1 to the processor if the processor is performing a radix-2 operation, couples the output of the radix-3 twiddle factor generator 210-2 to the processor if the processor is performing a radix-3 operation, and couples the output of the radix-5 twiddle factor generator 210-3 to the processor if the processor is performing a radix-5 operation. A drawback of the twiddle factor generator 410 in FIG. 4 is that it uses a separate LUT device for each radix size, which increases the area of a hardware implementation of the twiddle factor generator 410 because the LUTs may be individually implemented in hardware (to achieve a desired speed) rather than being created virtually, for example, in memory of a general purpose processor.

Embodiments of the present disclosure allow twiddle phase generators for different radix sizes to share a LUT device, as discussed further below. Hardware implementations of such embodiments consume less die area than hardware implementations of the embodiment of FIG. 4.

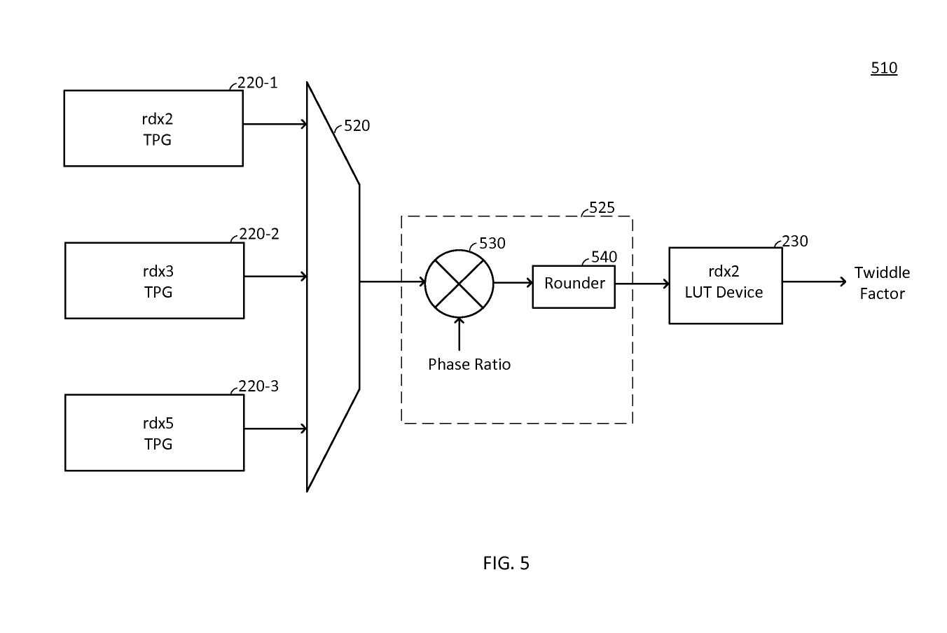

FIG. 5 shows a twiddle factor generator 510 according to an embodiment of the present disclosure. The twiddle factor generator 510 comprises a radix-2 TPG 220-1, a radix-3 TPG 220-2, and a radix-5 TPG 220-3. The radix-2 TPG 220-1 is configured to generate radix-2 twiddle phases from a set of radix-2 twiddle phases. The number of phases in the set of radix-2 twiddle phases may be given by 2^{S1}, where S1 is the maximum number of radix-2 stages that can be performed for a long-point DFT in a particular system. For example, if the maximum number of radix-2 stages is eleven, then the number of phases in the set of radix-2 twiddle phases is 2¹¹=2048.

In one aspect, the twiddle factors corresponding to the set of radix-2 twiddle phases may be given by:

$$Twiddle Factor = {e}^{- 2 j π \frac{n 1}{N 1}} \qquad ( 3 )$$

where N1 is the number of phases in the set of radix-2 twiddle phases, and n1 is an integer in the range of 0 to N1−1. According to equation (3), the twiddle factors corresponding to the set of radix-2 twiddle phases correspond to N1 equally-spaced points on a complex unit circle. In this aspect, the set of radix-2 twiddle phases may be represented by integers in the range of 0 to N1−1. Thus, when the radix-2 TPG 220-1 generates a radix-2 twiddle phase, the radix-2 TPG 220-1 may output the radix-2 twiddle phase in the form of an integer n1, in which the corresponding twiddle factor is given by equation (3). For the example where the number of phases in the set of radix-2 twiddle phases is 2048, equation (3) may be rewritten as:

$$Twiddle Factor = {e}^{- 2 j π \frac{n 1}{2048}} . \qquad ( 4 )$$

The radix-3 TPG 220-2 is configured to generate radix-3 twiddle phases from a set of radix-3 twiddle phases. The number of phases in the set of radix-3 twiddle phases may be given by 3^{S2}, where S2 is the maximum number of radix-3 stages that can be performed for a long-point DFT in a particular system. For example, if the maximum number of radix-3 stages is five, then the number of phases in the set of radix-3 twiddle phases is 3⁵=243.

In one aspect, the twiddle factors corresponding to the set of radix-3 twiddle phases may be given by:

$$Twiddle Factor = {e}^{- 2 j π \frac{n 2}{N 2}} \qquad ( 5 )$$

where N2 is the number of phases in the set of radix-3 twiddle phases, and n2 is an integer in the range of 0 to N2−1. According to equation (5), the twiddle factors corresponding to the set of radix-3 twiddle phases correspond to N2 equally-spaced points on a complex unit circle. In this aspect, the set of radix-3 twiddle phases may be represented by integers in the range of 0 to N2−1. Thus, when the radix-3 TPG 220-2 generates a radix-3 twiddle phase, the radix-3 TPG 220-2 may output the radix-3 twiddle phase in the form of an integer n2, in which the corresponding twiddle factor is given by equation (5). For the example where the number of phases in the set of radix-3 twiddle phases is 243, equation (5) may be rewritten as:

$$Twiddle Factor = {e}^{- 2 j π \frac{n 2}{243}} . \qquad ( 6 )$$

The radix-5 TPG 220-3 is configured to generate radix-5 twiddle phases from a set of radix-5 twiddle phases. The number of phases in the set of radix-5 twiddle phases may be given by 5^{S3}, where S3 is the maximum number of radix-5 stages in a DFT that can be performed for a long-point DFT in a particular system. For example, if the maximum number of radix-5 stages is two, then the number of phases in the set of radix-5 twiddle phases is 5²=25.

In one aspect, the twiddle factors corresponding to the set of radix-5 twiddle phases may be given by:

$$Twiddle Factor = {e}^{- 2 j π \frac{n 1}{N 1}} \qquad ( 7 )$$

where N3 is the number of phases in the set of radix-5 twiddle phases, and n3 is an integer in the range of 0 to N3−1. According to equation (7), the twiddle factors corresponding to the set of radix-5 twiddle phases correspond to N3 equally-spaced points on a complex unit circle. In this aspect, the set of radix-5 twiddle phases may be represented by integers in the range of 0 to N3−1. Thus, when the radix-5 TPG 220-3 generates a radix-5 twiddle phase, the radix-5 TPG 220-3 may output the radix-5 twiddle phase in the form of an integer n3, in which the corresponding twiddle factor is given by equation (7). For the example where the number of phases in the set of radix-5 twiddle phases is 25, equation (7) may be rewritten as:

$$Twiddle Factor = {e}^{- 2 j π \frac{n 3}{25}} . \qquad ( 8 )$$

The twiddle factor generator 510 also comprises a multiplexer 520, a phase converter 525, and a radix-2 LUT device 230. The radix-2 LUT device 230 is configured to receive a radix-2 twiddle phase (i.e., a phase from the set of radix-2 twiddle phases), and convert the radix-2 twiddle phase to a corresponding twiddle factor. For example, the radix-2 twiddle phase may be an integer n1 in the range of 0 to N1−1, and the radix-2 LUT device 230 may convert the radix-2 twiddle phase into the corresponding twiddle factor given by equation (3).

The phase converter 525 is configured to convert a radix-3 twiddle phase from the radix-3 TPG 220-2 into a corresponding radix-2 twiddle phase, which can be input to the radix-2 LUT device 230 to generate a twiddle factor for a radix-3 operation. Similarly, the phase converter 525 is configured to convert a radix-5 twiddle phase from the radix-5 TPG 220-3 into a corresponding radix-2 twiddle phase, which can be input to the radix-2 LUT device 230 to generate a twiddle factor for a radix-5 operation. Thus, the phase conversion allows the radix-2 LUT device 230 to be used to generate twiddle factors for radix-3 and radix-5 operations. In the embodiment shown in FIG. 5, the phase converter 525 comprises a multiplier 530 and a rounder 540. Operations of the multiplier 530 and the rounder 540 are discussed further below.

The multiplexer 520 is configured to couple the output of one of the TPGs 220-1 to 220-3 to the phase converter 525 depending on the size of the radix operation being performed, as discussed further below. Operations of the twiddle factor generator 510 for generating twiddle factors for different radix sizes will now be described according to various embodiments of the present disclosure.

When the twiddle factor generator 510 is used for a radix-2 operation, the multiplexer 520 couples the output of the radix-2 TPG 220-1 to the phase converter 525. In this case, phase conversion is not needed, and the phase converter 525 may simply pass radix-2 twiddle phases from the radix-2 TPG 220-1 to the radix-2 LUT device 230 for conversion to the corresponding twiddle factors. For example, the multiplier 530 may simply multiply the radix-2 twiddle phases by one. Alternatively, the radix-2 twiddle phases may bypass the phase converter 525 and go directly to the radix-2 LUT device 230. In this embodiment, the twiddle factor generator 510 may comprise a bypass path (not shown) that bypasses the phase converter 525 and one or more switches (not shown) configured to couple the radix-2 TPG 220-1 and the radix-2 LUT device 230 to the bypass path when a radix-2 operation is being performed.

When the twiddle factor generator 510 is used for a radix-3 operation, the multiplexer 520 couples the output of the radix-3 TPG 220-2 to the phase converter 525. The phase converter 525 converts each radix-3 twiddle phase from the radix-3 TPG 220-2 into a corresponding radix-2 twiddle phase that can be input to the radix-2 LUT device 230 to generate a twiddle factor. To do this, the multiplier 530 multiplies each radix-3 twiddle phase from the radix-3 TPG 220-2 by a phase ratio. In one embodiment, the phase ratio is a ratio of the number of phases in the set of radix-2 twiddle phases over the number of phases in the set of radix-3 twiddle phases. For the example in which the number of phases in the set of radix-2 twiddle phases is 2048, and the number of phases in the set of radix-3 twiddle phases is 243, the phase ratio is 2048/243. The rounder 540 rounds each output phase from the multiplier 530 to the nearest phase in the set of radix-2 twiddle phases. As a result, each rounded phase is a radix-2 twiddle phase (i.e., a phase in the set of radix-2 twiddle phases), and can therefore be input to the radix-2 LUT device 230 to generate a twiddle factor.

When the twiddle factor generator 510 is used for a radix-5 operation, the multiplexer 520 couples the output of the radix-5 TPG 220-3 to the phase converter 525. The phase converter 525 converts each radix-5 twiddle phase from the radix-5 TPG 220-3 into a corresponding radix-2 twiddle phase that can be input to the radix-2 LUT device 230 to generate a twiddle factor. To do this, the multiplier 530 multiplies each radix-5 twiddle phase from the radix-5 TPG 220-3 by a phase ratio. In one embodiment, the phase ratio is a ratio of the number of phases in the set of radix-2 twiddle phases over the number of phases in the set of radix-5 twiddle phases. The rounder 540 rounds each output phase from the multiplier 530 to the nearest phase in the set of radix-2 twiddle phases. As a result, each rounded phase is a radix-2 twiddle phase (i.e., a phase in the set of radix-2 twiddle phases), and can therefore be input to the radix-2 LUT device 230 to generate a twiddle factor.

The conversion of a radix-3 twiddle phase into a radix-2 twiddle phase according to one embodiment will now be discussed by way of the following example. In this example, it is assumed that the number of phases in the set of radix-2 twiddle phases is 2048 and the number of phases in the set of radix-3 twiddle phases is 243 for ease of discussion, although it is to be appreciated that this need not be the case.

In this example, the radix-3 TPG 220-2 may be configured to generate a radix-3 twiddle phase in the form of an integer n2 in the range of 0 to 242. The corresponding twiddle factor may be given by equation (6). The radix-2 LUT device 230 may be configured to receive a radix-2 twiddle phase in the form of an integer n1 in the range of 0 to 2047 and convert the radix-2 twiddle phase into a twiddle factor given by equation (4).

In this example, the multiplier 530 multiplies the radix-3 twiddle phase n2 from the radix-3 TPG 220-2 by the phase ratio 2048/243. The output phase of the multiplier 530 is given by:

$$output phase = n 2 \times \frac{2048}{243} . \qquad ( 9 )$$

The output phase is a number in the range of 0 to 2047, in which the number is not necessarily an integer. The rounder 540 rounds the output phase to the nearest integer, which may be expressed as:

$$rounded phase = ‖ n 2 \times \frac{2048}{243} ‖ . \qquad ( 10 )$$

Thus, the rounder 540 converts the output phase into an integer in the range of 0 to 2047, and therefore a radix-2 twiddle phase n1, which is an integer in the range of 0 to 2047 in this example.

Thus, the phase converter 525 in this example converts a radix-3 twiddle phase n2 from the radix-3 TPG 220-2 into a radix-2 twiddle phase n1 given by equation (10). The radix-2 twiddle phase n1 can then be input to the radix-2 LUT device 230, which outputs a twiddle factor given by:

$$Twiddle Factor = {e}^{- 2 j π \frac{‖ n 2 \times \frac{2048}{243} ‖}{2048}} . \qquad ( 11 )$$

The twiddle factor in equation (11) is obtained by plugging the radix-2 twiddle phase n1 given by equation (10) into equation (4). The twiddle factor given by equation (11) approximates the twiddle factor for the radix-3 twiddle phase n2 given by equation (6). This can be expressed as:

$${e}^{- 2 j π \frac{n 2}{243}} \approx {e}^{- 2 j π \frac{‖ n 2 \times \frac{2048}{243} ‖}{2048}} \qquad ( 12 )$$

where the left-hand side of the equation is the twiddle factor given by equation (6) for the radix-3 twiddle phase n2 output by the radix-3 TPG 220-2, and the right-hand side of the equation is the twiddle factor given by equation (4) for the radix-2 twiddle phase n1 output by the phase converter 525. The approximation between the two twiddle factors in equation (12) is due to the rounding operation performed by the rounder 540.

Thus, for a given radix-3 twiddle phase n2 from the radix-3 TPG 220-2, the phase converter 525 converts the radix-3 twiddle phase n2 into a corresponding radix-2 twiddle phase n1 that causes the radix-2 LUT device 230 to output a twiddle factor (given by equation (4)) closely matching the twiddle factor given by equation (6). This allows the radix-2 LUT device 230 to be used to generate a twiddle factor for a radix-3 twiddle phase n2 that closely matches the twiddle factor given by equation (6).

It is to be appreciated that the radix-2 LUT device 230 does not need to perform calculations according to equation (10) in order to output twiddle factors given by equation (10). For example, a plurality of twiddle factors may be pre-calculated according to equation (10) (e.g., during a design phase of a chip including the LUT device 230). A lookup table mapping the pre-calculated twiddle factors to the corresponding twiddle phases may then be stored in the LUT device 230 (e.g., in a read only memory (ROM) or other type of memory in the LUT device 230). During operation, when the LUT device 230 receives a twiddle phase, the LUT device 230 outputs the corresponding twiddle factor from the lookup table.

It is to be appreciated that embodiments of the present disclosure are not limited to the exemplary phase ratio of 2048/243 discussed above. In general, the phase ratio for converting a radix-3 twiddle phase into a radix-2 twiddle phase may be given by N1/N2 where N1 is the number of phases in the set of radix-2 twiddle phases and N2 is the number of phases in the set of radix-3 twiddle phases. The operations in the example discussed above may also be performed to convert a radix-5 twiddle phase into a radix-2 twiddle phase. In this case, the phase ratio may be given by N1/N3 where N1 is the number of phases in the set of radix-2 twiddle phases and N3 is the number of phases in the set of radix-5 twiddle phases.

Embodiments of the present disclosure may provide several advantages. First, the area of the twiddle factor generator 510 may be reduced by using the same LUT device (e.g., radix-2 LUT device 230) for different radix sizes instead of using a separate LUT device for each radix size (as shown in FIG. 4). Second, embodiments of the present disclosure are more scalable than the architecture shown in FIG. 4. This is because the architecture in FIG. 4 requires the addition of both a TPG and a LUT device to support an additional radix size (e.g., radix-7). In contrast, the architecture in FIG. 5 may only require the addition of a TPG to support an additional radix size since the same LUT device (e.g., radix-2 LUT device 230) may be used for different radix sizes. The phase converter (e.g., phase converter 525) may support the additional radix size by inputting the appropriate phase ratio to the phase converter.

Although FIG. 5 shows an example in which the twiddle factor generator 510 generates twiddle factors for radix-2, radix-3 and radix-5 operations, it is to be appreciated that embodiments of the present disclosure are not limited to this example. Embodiments of the present disclosure may be used to generate twiddle factors for different combinations of radix sizes. Further, although FIG. 5 shows an example in which a radix-2 LUT device is shared by the TPGs, it is to be appreciated that a LUT device for a different radix size may be shared by the TPGs instead.

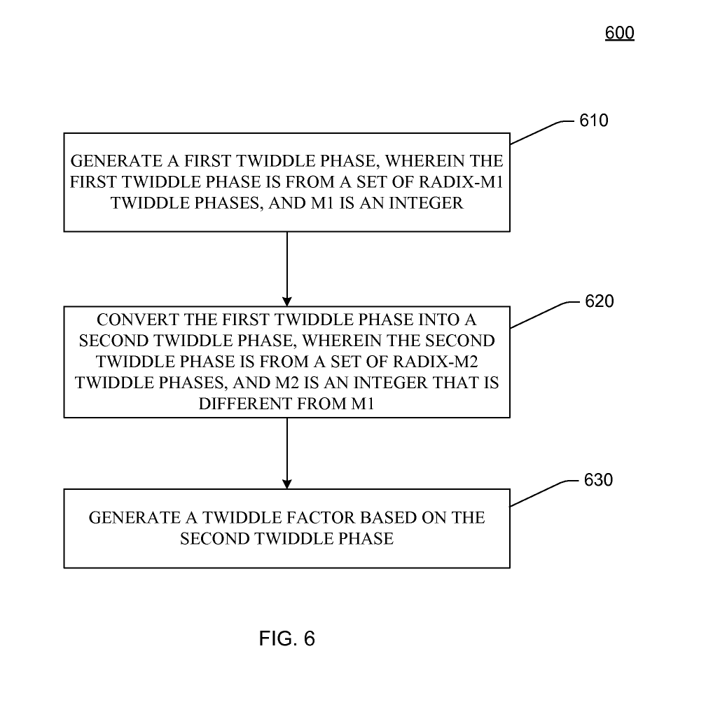

FIG. 6 illustrates a method 600 for twiddle factor generation according to an embodiment of the present disclosure. The method 600 may be performed by the twiddle factor generator 510.

In step 610, a first twiddle phase is generated, wherein the first twiddle phase is from a set of radix-M1 twiddle phases, and M1 is an integer. For example, the first twiddle phase may be generated by a TPG (e.g., TPG 220-2 or TPG 220-3), and radix-M1 may be radix-3, radix-5 or another radix size.

In step 620, the first twiddle phase is converted into a second twiddle phase, wherein the second twiddle phase is from a set of radix-M2 twiddle phases, and M2 is an integer that is different from M1. For example, radix-M2 may be radix-2 or another radix size. This step may be performed by a phase converter (e.g., phase converter 525), and may comprise multiplying the first twiddle phase by a phase ratio and rounding the resulting product. The phase ratio may be a ratio of the number of phases in the set of radix-M2 (e.g., radix-2) twiddle phases over the number of phases in the set of radix-M1 (e.g., radix-3 or radix-5) twiddle phases.

In step 630, a twiddle factor is generated based on the second twiddle phase. For example, the second twiddle phase may be input to a radix-M2 LUT device (e.g., radix-2 LUT device 230) to generate the twiddle factor.

The method 600 may optionally include generating a third twiddle phase, wherein the third twiddle phase is from a set of radix-M3 twiddle phases, and M3 is an integer that is different from M1 and M2. For example, the third twiddle phase may be generated by a twiddle phase generator (e.g., radix-5 TPG 220-3) that is different from a twiddle phase generator (e.g., radix-3 TPG 220-2) used to generate the first twiddle phase.

The method 600 may also optionally include converting the third twiddle phase into a fourth twiddle phase, wherein the fourth twiddle phase is from the set of radix-M2 twiddle phases. This step may comprise multiplying the third twiddle phase by a phase ratio and rounding the resulting product, in which the phase ratio may be a ratio of the number of phases in the set of radix-M2 (e.g., radix-2) twiddle phases over the number of phases in the set of radix-M3 (e.g., radix-3 or radix-5) twiddle phases.

The method 600 may further optionally include generating a second twiddle factor based on the fourth twiddle phase. For example, the four twiddle phase may be input to a radix-M2 LUT device (e.g., radix-2 LUT device 230) to generate the second twiddle factor.

The twiddle factor generator according to embodiments of the present disclosure is preferably implemented in hardware on a die rather than implemented in software that runs on a general purpose processor. This is because a general purpose processor may be too slow to keep up with high sample rates used in high-speed digital communications (e.g., digital communications according to an LTE standard).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A method for twiddle factor generation, comprising:
generating a first twiddle phase, wherein the first twiddle phase is from a set of radix-M1 twiddle phases, and M1 is an integer;
converting the first twiddle phase into a second twiddle phase, wherein the second twiddle phase is from a set of radix-M2 twiddle phases, and M2 is an integer that is different from M1; and
generating a twiddle factor based on the second twiddle phase.

2. The method of claim 1, wherein radix-M1 is one of radix-3 and radix-5, and radix-M2 is radix-2.

3. The method of claim 1, wherein converting the first twiddle phase into the second twiddle phase comprises:
multiplying the first twiddle phase by a phase ratio; and
rounding the multiplied twiddle phase to a nearest phase in the set of radix-M2 twiddle phases.

4. The method of claim 3, wherein the phase ratio is a ratio of a number of phases in the set of radix-M2 twiddle phases over a number of phases in the set of radix-M1 twiddle phases.

5. The method of claim 1, wherein generating the twiddle factor comprises inputting the second twiddle phase to a radix-M2 lookup table (LUT) device.

6. The method of claim 1, wherein the twiddle factor is a complex number on a unit circle in a complex plane.

7. The method of claim 1, further comprising:
generating a third twiddle phase, wherein the third twiddle phase is from a set of radix-M3 twiddle phases, and M3 is an integer that is different from M1 and M2;
converting the third twiddle phase into a fourth twiddle phase, wherein the fourth twiddle phase is from the set of radix-M2 twiddle phases; and
generating a second twiddle factor based on the fourth twiddle phase.

8. A twiddle factor generator, comprising:
a twiddle phase generator configured to generate a first twiddle phase, wherein the first twiddle phase is from a set of radix-M1 twiddle phases, and M1 is an integer;
a phase converter configured to convert the first twiddle phase into a second twiddle phase, wherein the second twiddle phase is from a set of radix-M2 twiddle phases, and M2 is an integer that is different from M1; and
a lookup table (LUT) device configured to generate a twiddle factor based on the second twiddle phase.

9. The twiddle factor generator of claim 8, wherein radix-M1 is one of radix-3 and radix-5, and radix-M2 is radix-2.

10. The twiddle factor generator of claim 8, wherein the phase converter comprises:
a multiplier configured to multiply the first twiddle phase by a phase ratio; and
a rounder configured to round the multiplied twiddle phase to a nearest phase in the set of radix-M2 twiddle phases.

11. The twiddle factor generator of claim 10, wherein the phase ratio is a ratio of a number of phases in the set of radix-M2 twiddle phases over a number of phases in the set of radix-M1 twiddle phases.

13. The twiddle factor generator of claim 8, further comprising:
a second twiddle phase generator configured to generate a third twiddle phase, wherein the third twiddle phase is from a set of radix-M3 twiddle phases, and M3 is an integer that is different from M1 and M2;
wherein the phase converter is configured to convert the third twiddle phase into a fourth twiddle phase, wherein the fourth twiddle phase is from the set of radix-M2 twiddle phase, and the LUT device is configured to generate a second twiddle factor based on the fourth twiddle phase.

14. The twiddle factor generator of claim 13, further comprising a multiplexer, wherein the multiplexer is configured to couple the first twiddle phase generator to the phase converter to generate the first twiddle factor, and to couple the second twiddle phase generator to the phase converter to generate the second twiddle factor.

15. The twiddle factor generator of claim 8, wherein the twiddle phase generator, the phase converter, and the LUT device are implemented in hardware.

16. A apparatus for twiddle factor generation, comprising:
means for generating a first twiddle phase, wherein the first twiddle phase is from a set of radix-M1 twiddle phases, and M1 is an integer;
means for converting the first twiddle phase into a second twiddle phase, wherein the second twiddle phase is from a set of radix-M2 twiddle phases, and M2 is an integer that is different from M1; and
means for generating a twiddle factor based on the second twiddle phase.

17. The apparatus of claim 16, wherein radix-M1 is one of radix-3 and radix-5, and radix-M2 is radix-2.

18. The apparatus of claim 16, wherein the means for converting the first twiddle phase into the second twiddle phase comprises:
means for multiplying the first twiddle phase by a phase ratio; and
means for rounding the multiplied twiddle phase to a nearest phase in the set of radix-M2 twiddle phases.

19. The apparatus of claim 18, wherein the phase ratio is a ratio of a number of phases in the set of radix-M2 twiddle phases over a number of phases in the set of radix-M1 twiddle phases.

20. The apparatus of claim 16, further comprising:
means for generating a third twiddle phase, wherein the third twiddle phase is from a set of radix-M3 twiddle phases, and M3 is an integer that is different from M1 and M2;
means for converting the third twiddle phase into a fourth twiddle phase, wherein the fourth twiddle phase is from the set of radix-M2 twiddle phases; and
means for generating a second twiddle factor based on the fourth twiddle phase.
